(19) United States
(12) Patent Application Publication
(10) Pub. No.: US 2016/0293357 A1
(43) Pub. Date: Oct. 6, 2016

(54) ELECTRONIC DEVICE, PRINTING DEVICE AND ELECTRONIC DEVICE PRODUCTION METHOD

(71) Applicant: CASIO COMPUTER CO., LTD., Tokyo (JP)

(72) Inventor: Kouji OSHIMA, Tokyo (JP)

(73) Assignee: CASIO COMPUTER CO., LTD., Tokyo (JP)

(21) Appl. No.: 15/080,015

(22) Filed: Mar. 24, 2016

(30) Foreign Application Priority Data
Apr. 6, 2015 (JP) 2015-077511

(51) Int. Cl. H01H 13/86; H01H 13/88; B41J 3/407

(52) U.S. Cl. CPC H01H 13/86; B41J 3/4075; H01H 13/88; H01H 2205/002; H01H 2223/04

(57) ABSTRACT

An electronic device, printing device, and electronic device production method in which a member comprising protruding pressing parts and plural members comprising openings into which the pressing parts are inserted are positioned with excellent accuracy are provided.

The electronic device (printing device) comprises a pressing member comprising plural protruding pressing parts, a first opening-formed member comprising plural first openings into which the plural pressing parts are so inserted as to individually protrude, a second opening-formed member comprising plural second openings into which the plural pressing parts inserted from the plural first openings are so inserted as to individually protrude, and a positioning member positioning the pressing member, first opening-formed member, and second opening-formed member so that the plural pressing parts are disposed at positions where the plural pressing parts are inserted in the plural first openings and plural second openings.

### CROSS-REFERENCE TO RELATED APPLICATION

This application claims the benefit of Japanese Patent Application No. 2015-077511, filed on Apr. 6, 2015, the entire disclosure of which is incorporated by reference herein.

### FIELD

This application relates generally to an electronic device, printing device, and electronic device production method.

### BACKGROUND

Electronic devices having protruding pressing parts such as input keys receiving input by pressing operations, printing devices, and methods producing such electronic devices are known.

For example, Japanese Patent No. 5477308 discloses an input device (tape printing device) having plural key caps to be pressed. In more detail, the input includes a body enclosure having plural through-holes into which plural key caps are individually inserted.

Then, in this input device, all key caps protrude by a specific amount with reference to the enclosure surface even if the key arrangement surface formed on the body enclosure is curved so that a user can operate the keys without experiencing awkward feelings.

For the above described electronic devices having protruding pressing parts, printing devices, and methods of producing the electronic devices, it is important that a member having protruding pressing parts and members having openings (through-holes) into which the pressing parts are inserted are positioned with excellent accuracy. If those members are not positioned with excellent accuracy, not only are the pressing parts not inserted into the openings for assembling the device, but also even if the pressing parts are inserted into the openings and the device is assembled, contact friction between the pressing parts and openings during pressing operations causes some damage to the device.

Particularly, when a pressing part is inserted into plural openings formed in plural different members, not into one opening, three or more members, a member having pressing parts and plural members having openings into which the pressing parts are inserted, have to mutually be positioned with excellent accuracy. Therefore, the accuracy of positioning is more important.

The present disclosure is made for solving the above problem and an objective of the disclosure is to provide an electronic device, printing device, electronic device production method in which a member having protruding pressing parts and plural members having openings into which the pressing parts are inserted are positioned with excellent accuracy.

### SUMMARY

In order to achieve the above objective, a mode of the electronic device, printing device, and electronic device production method according to the present disclosure includes:

a pressing member including plural protruding pressing parts;

a first opening-formed member including plural first openings in which the plural pressing parts are so inserted as to individually protrude;

a second opening-formed member including plural second openings in which the plural pressing parts inserted from the plural first openings are so inserted as to individually protrude; and

at least one positioning member positioning the pressing member, first opening-formed member, and second opening-formed member so that the plural pressing parts are disposed at positions where the plural pressing parts are inserted in the plural first openings and plural second openings.

The present disclosure can provide an electronic device, printing device, electronic device production method in which a member having protruding pressing parts and plural members having openings into which the pressing parts are inserted are positioned with excellent accuracy.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

A more complete understanding of this application can be obtained when the following detailed description is considered in conjunction with the following drawings, in which:

FIG. 1A is a perspective external view of a printing device according to an embodiment of the present disclosure;

FIG. 1B is a side view of the printing device seen in the direction of an arrow B shown in FIG. 1A;

FIG. 2A is a plane view of the printing device according to the embodiment of the present disclosure;

FIG. 2B is a bottom view of the printing device according to the embodiment of the present disclosure;

FIG. 3A is a perspective external view of a tape cassette;

FIG. 3B is an enlarged internal view of the printing device according to the embodiment of the present disclosure;

FIG. 4 is perspective views of a key cover, upper case, rubber key, and printed wiring board;

FIG. 5A is a plane view of the rubber key;

FIG. 5B is a plane view of the printed wiring board;

FIG. 6 is a plane view of the upper case;

FIG. 7A is a plane view of the key cover seen from the front side;

FIG. 7B is a plane view of the key cover seen from the back side;

FIG. 8A is cross-sectional views of the key cover, upper case, rubber key, and printed wiring board at the line A-A shown in FIGS. 5A to 7B;

FIG. 8B is a cross-sectional view of the four members shown in FIG. 8A after assembled;

FIG. 9A is cross-sectional views of the key cover, upper case, rubber key, and printed wiring board at the line B-B shown in FIGS. 5A to 7B;

FIG. 9B is a cross-sectional view of the four members shown in FIG. 9A after assembled;

FIG. 10A is cross-sectional views of the key cover, upper case, rubber key, and printed wiring board at the line C-C shown in FIGS. 5A to 7B; and

FIG. 10B is a cross-sectional view of the four members shown in FIG. 10A after assembled.

### DETAILED DESCRIPTION

An embodiment of the present disclosure will be described hereafter with reference to the drawings. In the figures, the same or corresponding components are referred to by the same reference numbers.

In the embodiment below, a printing device (label printer) is described as the electronic device according to the present disclosure by way of example.

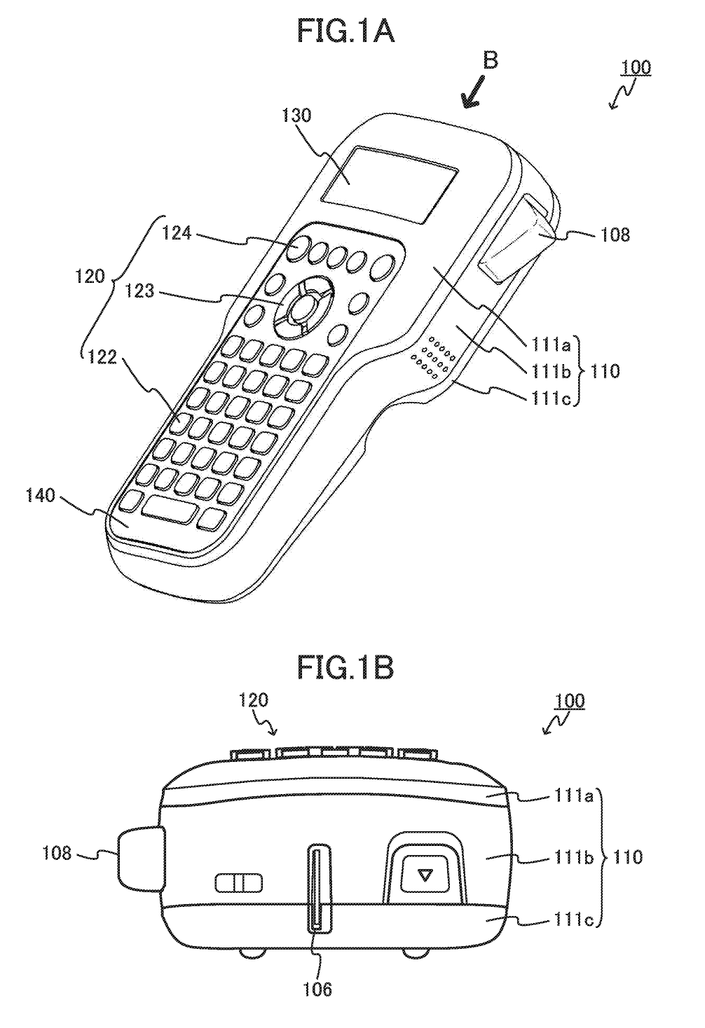

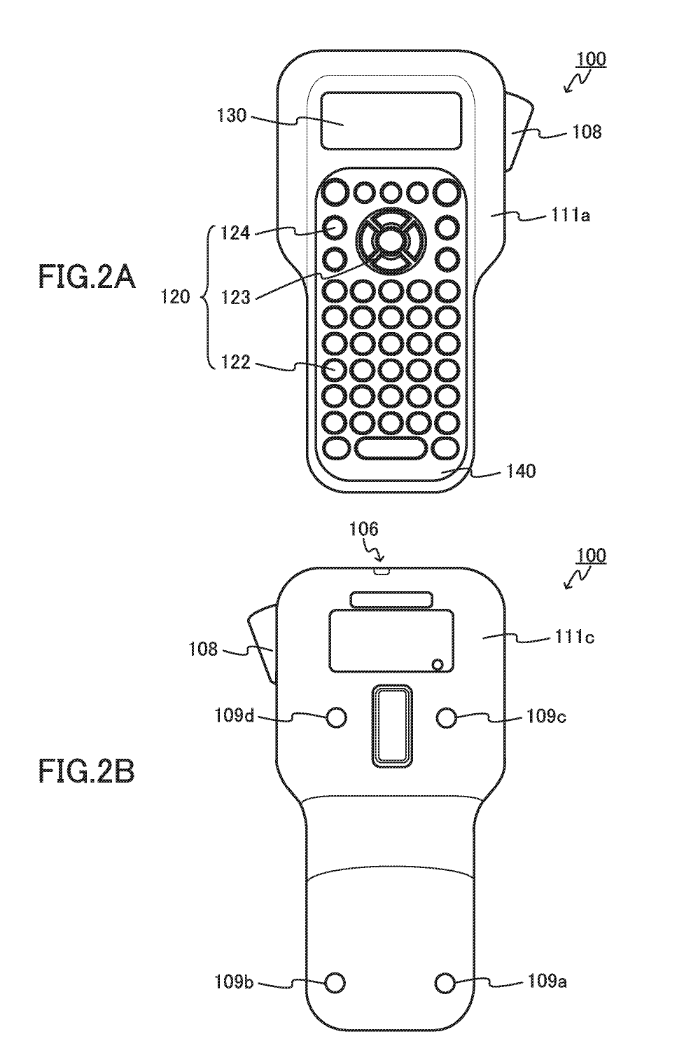

FIG. 1A shows a perspective external view of a printing device 100 according to an embodiment of the present disclosure. FIG. 1B shows a side view of the printing device 100 (the side seen in the direction of an arrow B in FIG. 1A). Moreover, FIGS. 2A and 2B show a front view and back view of the printing device 100, respectively.

The printing device 100 is a compact label printer small enough for a user to hold in one hand. The printing device 100 prints print patterns including graphic, character, and other patterns on a printing medium that is a tape material formed by laminating a printing tape having a printing surface on the front and an adhesive surface on the back and a releasable tape attached to the adhesive surface.

The printing device 100 includes a synthetic resin enclosure 110 constructed by combining three cases, an upper case 111a, a middle case 111b, and a lower case 111c. The enclosure 110 houses a thermal head, printed wiring board, and the like, which will be descried later. The enclosure 110 is narrower and thinner in the lower part than in the upper part in the longitudinal direction so that the user can easily hold the lower part in the longitudinal direction. Thus, the user can enter a desired print pattern and print the pattern on the tape material while holding the printing device 100.

Moreover, the printing device 100 includes an inputter 120 and a display 130 on the front side of the upper case 111a.

The inputter 120 includes plural rubber press keys 122, 123, and 124 functioning as input keys.

The press keys 122 are character input keys arranged nearly in the lower half region of the upper case 111a in the longitudinal direction for the user to enter character data. The press keys 122 are arranged in a two-dimensional array (a grid) of seven horizontal rows and five vertical columns (except for three columns in the lowermost row) as shown in FIGS. 1A and 2A. The press keys 123 are keys including four cursor keys arranged in a circle in the center region of the upper case 111a and a circular enter key surrounded by these four cursor keys. The four cursor keys are keys for moving a cursor on the display screen of the display 130 and the enter key is the key for selecting an item on which the cursor is placed. The press keys 124 are control keys arranged around the press keys 123 functioning as the cursor keys and enter key for setting the print modes and conducting various setting operations. Operating the press keys 122, 123 and 124 of the inputter 120, the user can enter, for example, characters to print on a tape material, commands for print start and/or setting changes, and the like.

The display 130 includes a display screen such as a liquid crystal display panel as a main panel of the printing device 100. The display 130 displays, for example, information regarding entered data (images, a selection menu for various settings, messages regarding various operations, and the like).

Moreover, the printing device 100 includes a key cover 140 in the portion of the upper case 111a where the inputter 120 is provided. The key cover 140 is a synthetic resin member covering the surface of the upper case 111a in part for the purpose of improving the printing device 100 in strength and design (industrial design).

Plural openings corresponding to the plural press keys 122, 123, and 124 are formed in the key cover 140 and upper case 111a as described in detail later. The plural press keys 122, 123, and 124 are individually inserted into the openings formed in the upper case 111a and the openings formed in the key cover 140 and slightly protrude from the openings of the key cover 140 so that the user can easily press the press keys 122, 123, and 124. A large opening into which the plural press keys 122, 123, and 124 are inserted all together may be formed in the upper case 111a, instead of plural openings corresponding to the plural press keys 122, 123, and 124 on a one-to-one basis. In such a case, the strength of the upper case 111a is lowered.

As shown in FIG. 1B, the printing device 100 includes a tape dispenser 106 from which the printed tape material is dispensed on a side of the enclosure 110 (the side seen in the direction of the arrow B in FIG. 1A). Moreover, the printing device 100 includes a cutter operation lever 108 for cutting the tape material on which a print pattern is printed on a side of the enclosure 110 (the right side when the user squarely faces the front of the upper case 111a).

As shown in FIG. 2B, the printing device 100 includes four protrusions 109a to 109d on the back (the lower case 111c) so that the printing device 100 is stably placed on a table or the like. Moreover, although not shown, the printing device 100 comprises a power switch for switching the printing device 100 between power-on and power-off, power supply terminals to which a power code is connected, terminals for connecting to an external device such as a personal computer, a slot into which a storage medium such as a memory card is inserted, and the like.

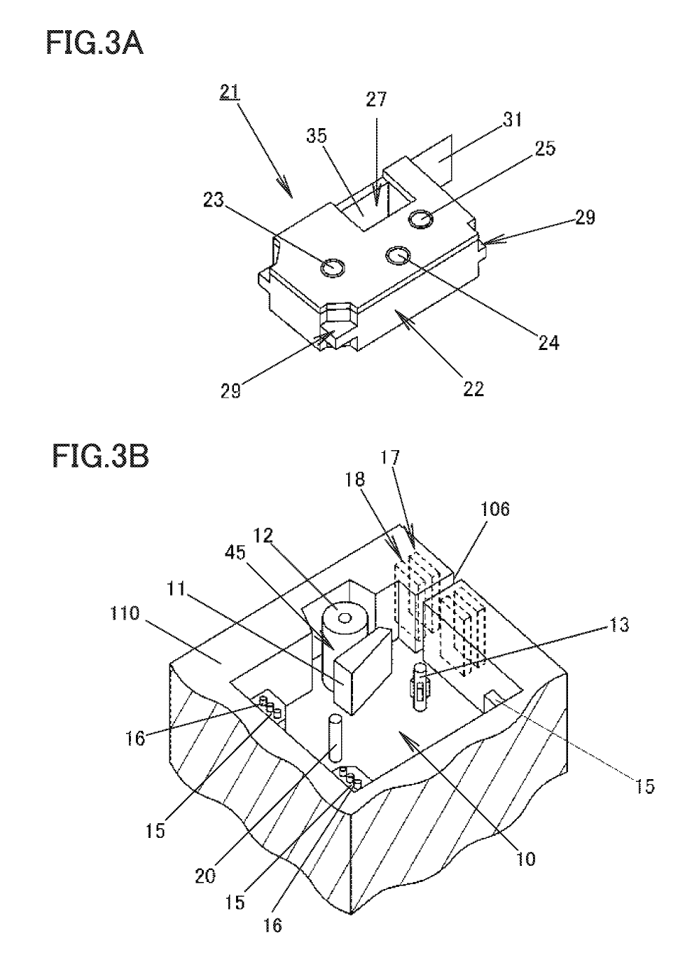

FIG. 3A shows the appearance of a tape cassette 21 used with the printing device 100. Moreover, FIG. 3B shows a perspective view of a part of the internal structure of the printing device 100.

As shown in FIG. 3B, a tape housing 10 for housing (loading) the tape cassette 21 containing a tape material 31 and an ink ribbon 35 is formed inside the enclosure 110. A printing mechanism 45 as a printer and cassette receivers 15 for supporting the tape cassette 21 at a given position are formed inside the tape housing 10.

The printing mechanism 45 includes printing elements arranged in the vertical direction, a print head (thermal head) 11, a platen roller 12 clamping and transferring the tape material 31 and ink ribbon 35 together with the print head 11, a positioning shaft 20 engaging with and positioning the tape cassette 21, and a ribbon take-up shaft 13 taking up the ink ribbon 35 used for printing into the tape cassette 21. The printing mechanism 45 prints a print pattern regarding data entered from the inputter 120 on a printing medium.

Moreover, the tape dispenser 106 leading to the outside of the enclosure 110 is formed at one end of the tape housing 10. A full-cut mechanism 17 as full-cut means for cutting the printing tape and releasable tape of the tape material 31 crosswise and a half-cut mechanism 18 as half-cut means for cutting only the printing tape of the tape material 31 and leaving the releasable tape uncut are installed in the tape dispenser 106.

FIG. 3A shows the appearance of the tape cassette 21 used with the printing device 100. The tape cassette 21 includes a cassette casing 22. A tape core 23 around which the tape material 31 is wound, a ribbon feed core 24 around which an unused ink ribbon 35 is wound, and a ribbon take-up core 25 taking up the used ink ribbon 35 are each housed in the cassette casing 22. Moreover, a head positioner 27 in which the print head 11 is positioned when the tape cassette 21 is loaded in the tape housing 10 is formed in the cassette casing 22 of the tape cassette 21.

Engagees 29 engaging with the cassette receivers 15 of the tape housing 10 and supported by the cassette receivers 15 are formed at the corners of the cassette casing 22. Then, not-shown given uneven surfaces are formed on the engagees 29 of the cassette casing 22 in accordance with the type of the tape cassette 21, and given tape width detection switches 16 determining the uneven surfaces formed on the engagees 29 of the cassette casing 22 when the tape cassette 21 is loaded are formed on the cassette receivers 15 of the tape housing 10.

In the printing device 100, as the tape cassette 21 is loaded in the tape housing 10, some or all of the engagees 29 of the cassette casing 22 and the tape width detection switches 16 formed on the cassette receivers 15 of the tape housing 10 engage and the engaged tape width detection switches 16 are pressed down. The printing device 100 determines the type of the tape cassette 21 such as the tape width according to the combination of the tape width detection switches 16 turned on.

In other words, since the type of the tape cassette 21 varies depending on the width and the like of the contained tape material 31, the printing device 100 determines the type of the tape cassette 21 to identify the width, color, and the like of the tape that is the printing target, and creates print data suitable for the tape width.

As the printing is ordered, the tape material 31 and ink ribbon 35 are dispensed from the tape cassette 21. The tape material 31 and ink ribbon 35 are clamped and transferred between the platen roller 12 and print head 11 in the laminated state.

Then, the print head 11 is thermally activated based on the print data so that the ink of the ink ribbon 35 is heat-transferred to the printing tape of the tape material 31 for printing.

As the printing ends, the user operates the cutter operation lever 108 to activate the full-cut mechanism 17 or half-cut mechanism 18 so as to cut the tape material 31 crosswise and create a piece of tape-like label.

The configurations of the upper case 111a and other members fixed together with the upper case 111a such as the key cover 140 in the printing device 100 having the above-described configuration will be described in detail hereafter.

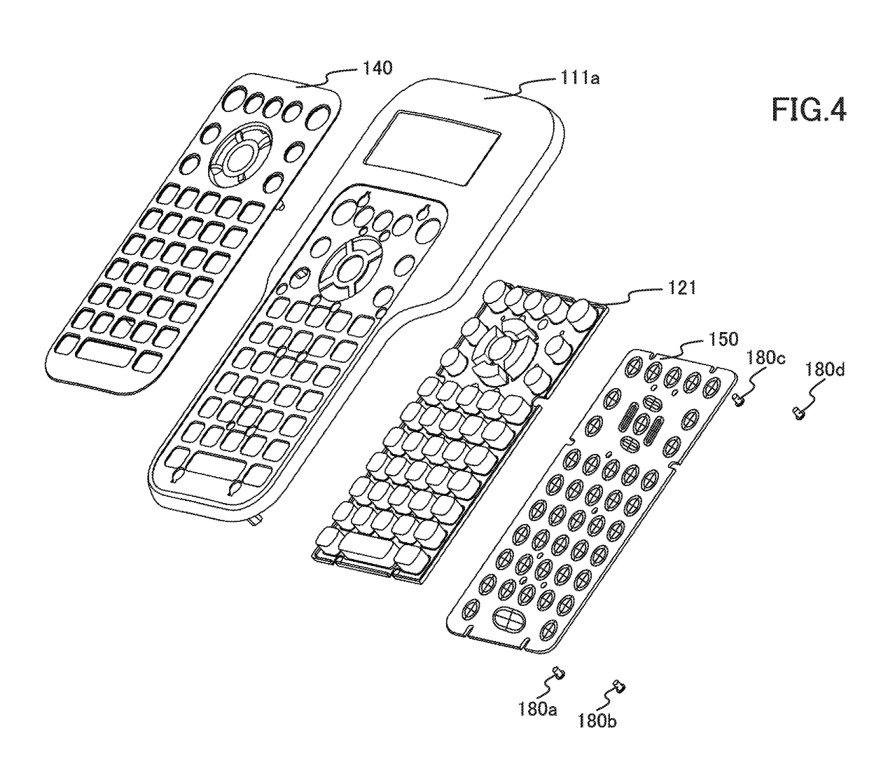

FIG. 4 shows an exploded view of the members fixed together with the upper case 111a. As shown in FIG. 4, the key cover 140 is placed on the front side of the upper case 111a (outside the enclosure 110) and a rubber key 121 and a printed writing board (PWB) 150 are placed on the back side of the upper case 111a (inside the enclosure 110). In other words, from the front side (outside) of the enclosure 110, the key cover 140, upper case 111a, rubber key 121, and printed wiring board 150 are superposed in sequence and fixed with four screws 180a to 180d that are common fixing members.

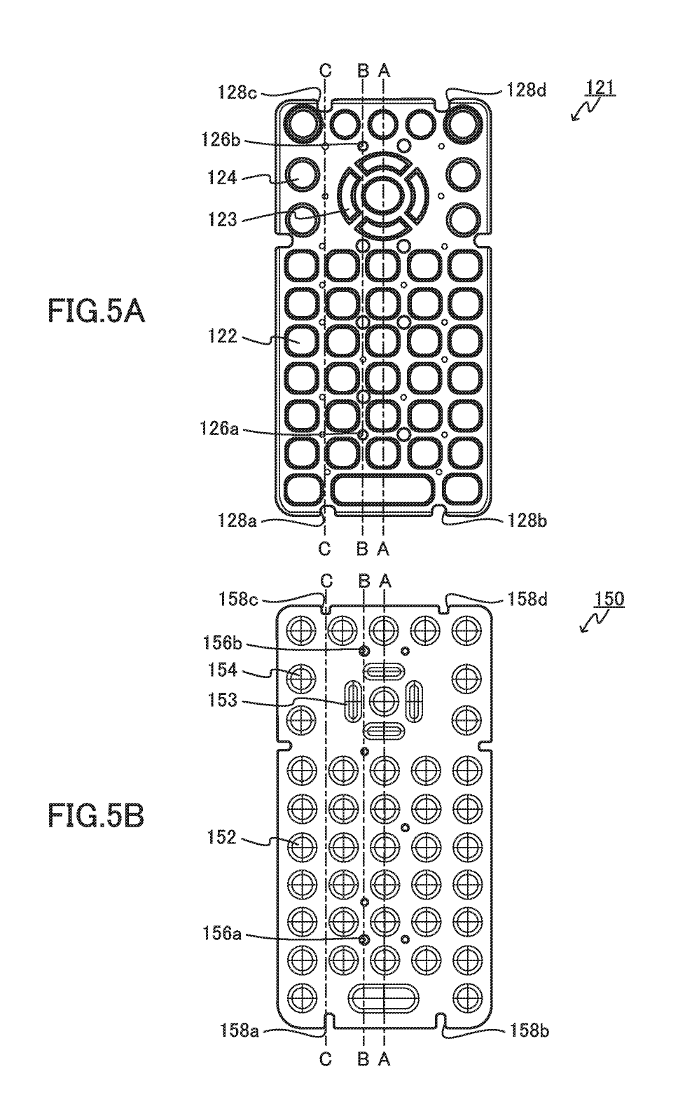

FIG. 5A shows the configuration of the rubber key 121. The rubber key 121 is a pressing member having plural protruding pressing parts arranged in a plane. As shown in FIG. 5A, the rubber key 121 has the press keys 122, 123, and 124 as the plural protruding pressing parts.

The press keys 122, 123 and 214 are, as described above, character input keys arranged in a grid, four cursor keys arranged in a circle and an enter key surrounded by these four cursor keys, and control keys so arranged as to surround the cursor keys and enter key, respectively. As each of the press keys 122, 123, and 124 is pressed by the user, the cap of the pressed key is pressed down under a load by the pressing and the contact of the cap makes contact with an electrode provided on the printed wiring board 150. Released from the pressing by the user, the cap of the pressed key returns to the ordinary position based on the elastic force of the rubber.

Moreover, openings 126a and 126b and notches 128a to 128d are formed in the rubber key 121.

The openings 126a and 126b are circular positioning holes (pinholes) into which positioning pins 146a and 146b provided on the key cover 140 (described in detail later) are inserted, respectively. The opening 126a is provided between the press keys 122 arranged in a grid, namely at a position where two grid lines (grids) intersect, in the lower region of the rubber key 121 in the longitudinal direction. On the other hand, the opening 126b is provided between the press keys 123 arranged in a circle and the press keys 124 surrounding the press keys 123 in the upper region of the rubber key 121 in the longitudinal direction. In the following explanation, openings 116a and 116b formed in the upper case 111a (described in detail later) are called third openings 116a and 116b, respectively, and the openings 126a and 126b formed in the rubber key 121 are called fourth openings 126a and 126b, respectively.

The notches 128a to 128d are patterns formed for fixing the rubber key 121. In more detail, two notches 128a and 128b are provided at the lower end of the rubber key 121 and two notches 128c and 128d are provided at the upper end of the rubber key 121. Protrusions 148a to 148d provided on the key cover 140 (described in detail later) are inserted into the four notches 128a to 128d, respectively.

FIG. 5B shows the configuration of the printed wiring board 150. The printed wiring board 150 is a signals processing member having circuits processing signals generated when the press keys 122, 123, and 124 are pressed and having fifth openings formed. As shown in FIG. 5B, the printed wiring board 150 has electrodes 152, 153, and 154 on the surface faced with the rubber key 121 (namely, the front).

The electrodes 152, 153, and 154 correspond to the press keys 122, 123, and 124 on a one-to-one basis and are arranged in the same manner as the press keys 122, 123, and 124 provided on the rubber key 121. In more detail, the electrodes 152 are arranged in a grid in the lower to center region of the printed wiring board 150 in the longitudinal direction like the press keys 122 that are character input keys. The electrodes 153 include four electrodes arranged in a circle and an electrode surrounded by these four electrodes like the press keys 123 that are cursor keys and an enter key. The electrodes 154 are so arranged as to surround the electrodes 153 arranged in a circle like the press keys 124 that are control keys.

As each of the press keys 122, 123, and 124 provided on the rubber key 121 is pressed, the cap of the key pressed down by the pressing makes contact with the corresponding electrode on the printed wiring board 150. As the cap of the key makes contact with the electrode, a control signal corresponding to the pressed key is generated and output from the wire connected to the electrode.

Moreover, openings 156a and 156b and notches 158a to 158d are formed in the printed wiring board 150.

The openings 156a and 156b are circular positioning holes (pinholes) into which the positioning pins 146a and 146b provided on the key cover 140 (described in detail later) are inserted, respectively. The openings 156a and 156b are so positioned as to align with the fourth openings 126a and 126b formed in the rubber key 121, respectively. In more detail, the opening 156a is provided between the electrodes 152 arranged in a grid, namely at a position where two grid lines (grids) intersect, in the lower region of the printed wiring board 150 in the longitudinal direction. On the other hand, the opening 156b is provided between the electrodes 153 arranged in a circle and the electrodes 154 surrounding the electrodes 153 in the upper region of the printed wiring board 150 in the longitudinal direction. In the following explanation, the openings 156a and 156b are called fifth openings 156a and 156b, respectively.

The notches 158a to 158d are patterns formed for fixing the printed wiring board 150. The four notches 158a to 158d are so positioned as to align with the four notches 128a to 128d formed in the rubber key 121. In more detail, two notches 158a and 158b are provided at the lower end of the printed wiring board 150 and two notches 158c and 158d are provided at the upper end of the printed wiring board 150. The protrusions 148a to 148d provided on the key cover 140 (described in detail later) are inserted into the notches 158a to 158d, respectively.

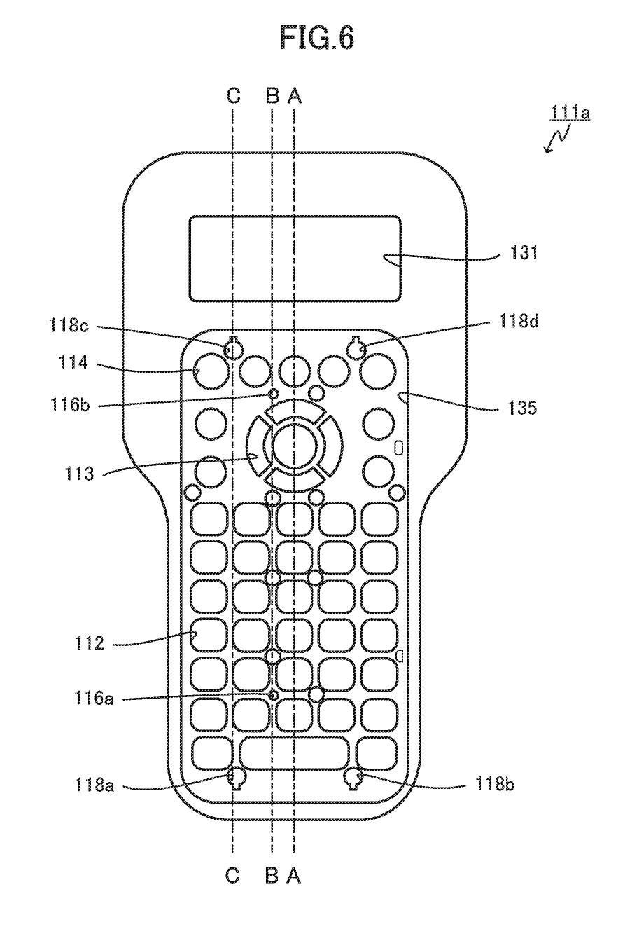

FIG. 6 shows the configuration of the upper case 111a. The upper case 111a is a member constituting a part of the enclosure 110 of the printing device 100 as described above. Moreover, the upper case 111a is a first opening-formed member in which plural openings including openings 112, 113, and 114 are formed as shown in FIG. 6.

The openings 112, 113, and 114 are formed in a recess 135 formed in a surface of the upper case 111a. The openings 112, 113, and 114 are each a hole into which the corresponding press key is inserted among the press keys 122, 123, and 124 that are plural protruding pressing parts provided on the rubber key 121. Therefore, the openings 112, 113, and 114 correspond to the press keys 122, 124, and 124 on a one-to-one basis and are arranged in the same manner as the press keys 122, 123, and 124. In more detail, the openings 112 are formed in a grid in the lower region of the upper case 111a in the longitudinal direction like the press keys 122 that are character input keys. The openings 113 include four openings arranged in a circle and an opening surrounded by these four openings like the press keys 123 that are cursor keys and an enter key. The openings 114 are so formed as to surround the openings 113 arranged in a circle like the press keys 124 that are control keys. In the following explanation, the openings 112, 113, and 114 are called first openings 112, 113, and 114, respectively.

The first openings 112, 113, and 114 each have the same shape as the corresponding press key. Then, the first openings 112, 113, and 114 are each nearly equal or slightly larger in size (diameter) to or than the corresponding press key so that the inserted, corresponding press key can smoothly move up and down due to pressing operations of the user.

In addition to the above-described first openings 112, 113, and 114 into which the press keys 122, 123, and 124 are inserted, openings 116a and 116b and openings 118a to 118d are formed within the recess 135 formed in the upper case 111a.

The openings 116a and 116b are circular positioning holes (pinholes) into which the positioning pins 146a and 146b provided on the key cover 140 (described in detail later) are inserted, respectively. The openings 116a and 116b are so positioned as to align with the fourth openings 126a and 126b formed in the rubber key 121. In more detail, the opening 116a is provided between the openings 112 formed in a grid, namely at a position where two grid lines (grid) intersect, in the lower region of the upper case 111a in the longitudinal direction. On the other hand, the opening 116b is provided between the openings 113 arranged in a circle and the openings 114 surrounding the openings 113 in the upper region of the upper case 111a in the longitudinal direction. In the following explanation, the openings 116a and 116b are called third openings 116a and 116b, respectively.

The openings 118a to 118d are holes formed for fixing the upper case 111a. The four openings 118a to 118d are so positioned as to align with the four notches 128a to 128d formed in the rubber key 121. In more detail, two openings 118a and 118b are provided at the lower end of the recess 135 and two openings 118c and 118d are provided at the upper end of the recess 135. The protrusions 148a to 148d provided on the key cover 140 (described in detail later) are inserted into the four openings 118a to 118d, respectively.

Moreover, an opening 131 for the display 130 is formed in the upper part of the upper case 111a in the longitudinal direction. A liquid crystal display panel or the like constituting the display 130 is inserted into the opening 131. The user can view various displayed images displayed on the display 130 through the opening 131.

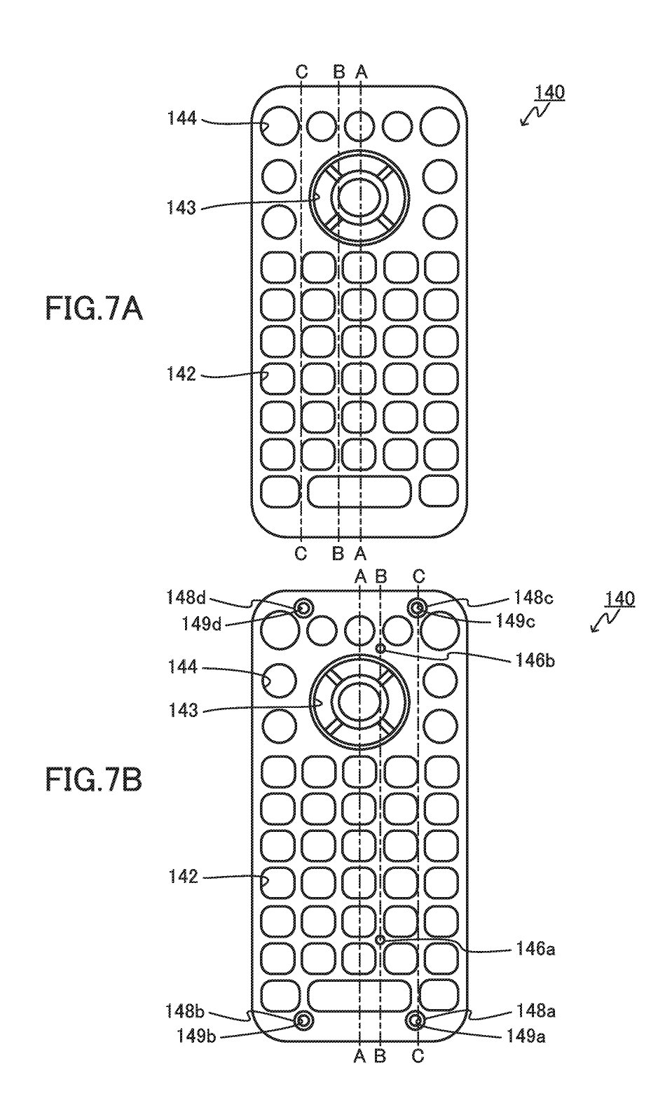

FIGS. 7A and 7B show the configuration of the key cover 140. The key cover 140 is a member housed in the recess (dent) 135 formed in a surface of the upper case 111a and covering the surface of the upper case 111a in part.

Housed in the recess 135 of the upper case 111a, the key cover 140 covers a portion of the upper case 111a where the first openings 112, 113, and 114 are formed. The portion where the first openings 112, 113, and 114 are formed tends to receive a load due to pressing operations of the user. Therefore, the key cover 140 covers the upper case 111a to create a double-layer structure, thereby improving the strength.

Moreover, although presented colorless in the figure for avoiding intricacy, it is possible to make the key cover 140 different in color from the upper case 111a so as to improve the printing device 100 in design (industrial design). In other words, the key cover 140 and upper case 111a are generally produced by metal molding such as injection molding and therefore it is difficult to produce one and the same member having plural colors. Providing the key cover 140 as a separate member in addition to the upper case 111a easily makes it possible to present the appearance of the printing device 100 in plural different colors.

Furthermore, the key cover 140 can be used to hide poor appearance of the upper case 111a for improvement in design. For example, a port (gate) for introducing resin in the metal molding is often provided in the center of the molded article (around the area where the first openings 112, 113, and 114 are formed in the case of the upper case 111a) and easily causes poor appearance. Therefore, the key cover 140 covering the upper case 111a can make invisible the poor appearance of the upper case 111a that has occurred in the course of production.

The configuration of the key cover 140 will be described in detail hereafter. The key cover 140 is a second opening-formed member in which plural openings including openings 142, 143, and 144 are formed as shown in FIG. 7A.

The openings 142, 143, and 144 are each a hole into which the corresponding press key is inserted among the press keys 122, 123, and 124 that are plural protruding pressing parts provided on the rubber key 121. Therefore, the openings 142, 143, and 144 correspond to the press keys 122, 123, and 124 on a one-to-one basis and are arranged in the same manner as the press keys 122, 123, and 124. In more detail, the openings 142 are formed in a grid in the lower to center region of the key cover 140 in the longitudinal direction like the press keys 122 that are character input keys. The openings 143 include four openings arranged in a circle and an opening surrounded by these four openings like the press keys 123 that are cursor keys and an enter key. The openings 144 are so formed as to surround the openings 143 arranged in a circle like the press keys 124 that are control keys. In the following explanation, the openings 142, 143, and 144 are called second openings 142, 143, and 144, respectively.

The second openings 142, 143, and 144 are so positioned as to align with the first openings 112, 113, and 114 formed in the upper case 111a, respectively. Therefore, after the key cover 140 is superposed on the upper case 111a and fixed, the press keys 122, 123, and 124 protruding from the openings 112, 113, and 114 formed in the upper case 111a are inserted into the second openings 142, 143, and 144. In other words, the press keys 122, 123, and 124 each pass through two openings, the corresponding opening among the first openings 112, 113, and 114 formed in the upper case 111a and the corresponding opening among the second openings 142, 143, and 144 formed in the key cover 140.

The second openings 142, 143, and 144 each have the same shape as the corresponding press key. Then, the second openings 142, 143, and 144 are each nearly equal or slightly larger in size (diameter) to or than the corresponding press key so that the inserted, corresponding press key can smoothly move up and down due to pressing operations of the user.

Moreover, the key cover 140 has positioning pins 146a and 146b and protrusions 148a to 148d on the back as shown in FIG. 7B.

The positioning pins 146a and 146b are common positioning members that are positioning protrusions protruding from the back of the key cover 140 in the direction perpendicular to the back and serve for collectively positioning the key cover 140, upper case 111a, rubber key 121, and printed wiring board 150.

The positioning pins 146a and 146b are provided at positions corresponding to the third openings 116a and 116b formed in the upper case 111a, the fourth openings 126a and 126b formed in the rubber key 121, and the fifth openings 156a and 156b formed in the printed wiring board 150. In more detail, the positioning pin 146a is provided between the openings 142 formed in a grid, namely at a position where two grid lines (grids) intersect, in the lower region of the key cover 140 in the longitudinal direction. On the other hand, the positioning pin 146b is provided between the openings 143 arranged in a circle and the openings 144 surrounding the openings 143 in the upper region of the key cover 140 in the longitudinal direction.

The positioning pin 146a is inserted into the third opening 116a formed in the upper case 111a, the fourth opening 126a formed in the rubber key 121, and the fifth opening 156a formed in the printed wiring board 150. The positioning pin 146b is inserted into the third opening 116b formed in the upper case 111a, the fourth opening 126b formed in the rubber key 121, and the fifth opening 156b formed in the printed wiring board 150. As a result, four members, the key cover 140, upper case 111a, rubber key 121, and printed wiring board 150, are collectively positioned so as not to shift in the longitudinal direction and in the width direction of the printing device 100. Here, the third opening 116a, fourth opening 126a, and fifth opening 156a have the same shape as the corresponding positioning pin 146a and are each nearly equal in size (diameter) to the corresponding positioning pin 146a so as to be precisely positioned as the corresponding positioning pin 146a is inserted. Moreover, the third opening 116b, fourth opening 126b, and fifth opening 156b have the same shape as the corresponding positioning pin 146b and are each nearly equal in size (diameter) to the corresponding positioning pin 146b so as to be precisely positioned as the corresponding positioning pin 146b is inserted.

The protrusions 148a to 148d are fixing protrusions. The four protrusions 148a to 148d are provided at positions corresponding to the openings 118a to 118d formed in the upper case 111a, the four notches 128a to 128d formed in the rubber key 121, and the four notches 158a to 158d formed in the printed wiring board 150. In more detail, two protrusions 148a and 148b are provided at the lower end of the key cover 140 and two protrusions 148c and 148d are provided at the upper end of the key cover 140.

Screw holes 149a to 149b having a threaded inner surface are formed in the protrusions 148a and 148d, respectively. Four screws 180a to 180d that are common fixing members are inserted into the four screw holes 149a to 149d, respectively.

In more detail, with the four protrusions 148a to 148d provided on the key cover 140 being inserted into the openings 118a to 118d of the upper case 111a, the notches 128a to 128d of the rubber key 121, and the notches 158a to 158d of the printed wiring board 150, the four screws 180a to 180d having a threaded outer surface are inserted into the screw holes 149a to 149d from more inside than the printed wiring board 150 and fastened. As a result, four members, the key cover 140, upper case 111a, rubber key 121, and printed wiring board 150, are fixed (fastened) by a small number of fixing members, namely four screws 180a to 180d. Here, inserted into the openings 118a to 118d of the upper case 111a, the notches 128a to 128d of the rubber key 121, and the notches 158a to 158d of the printed wiring board 150, the four protrusions 148a to 148d provided on the key cover 140 also serve for further positioning the four members, the key cover 140, upper case 111a, rubber key 121, and printed wiring board 150.

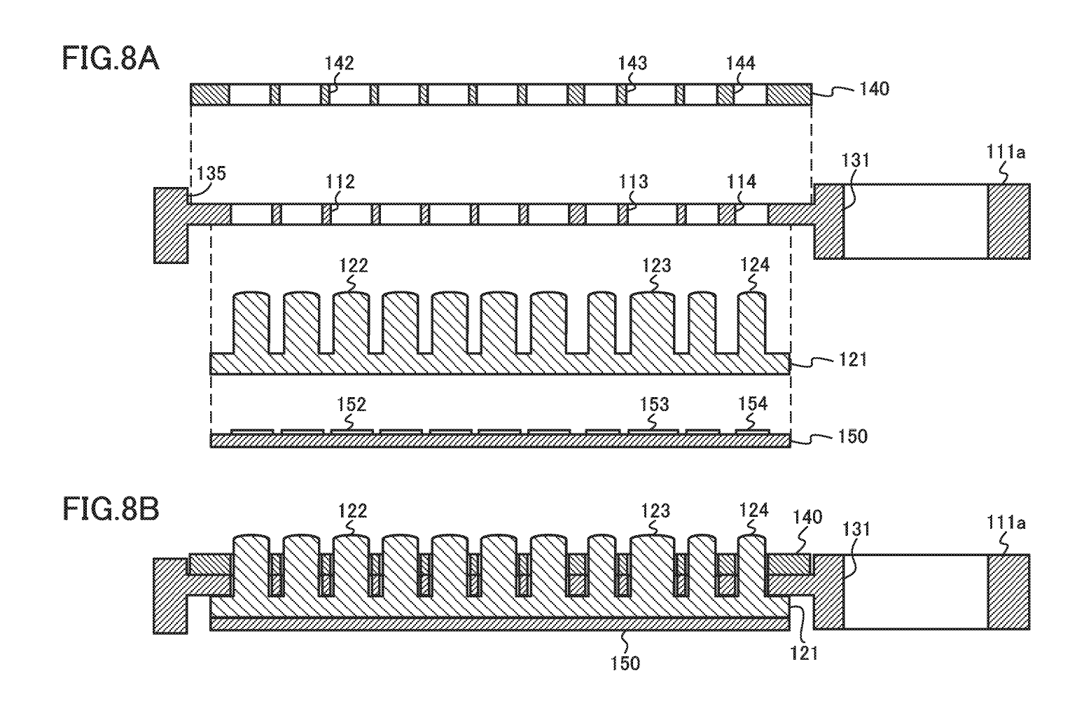

The cross-sectional configuration of the key cover 140, upper case 111a, rubber key 121, and printed wiring board 150 configured as described above will be described with reference to FIGS. 8A to 10B.

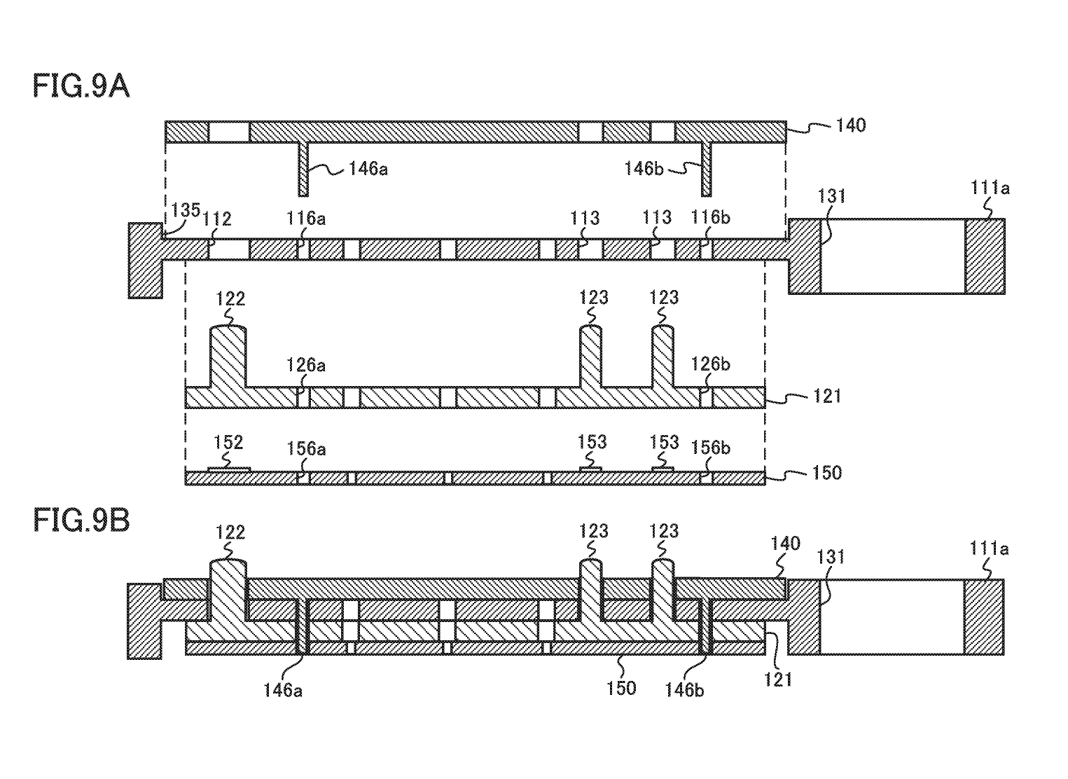

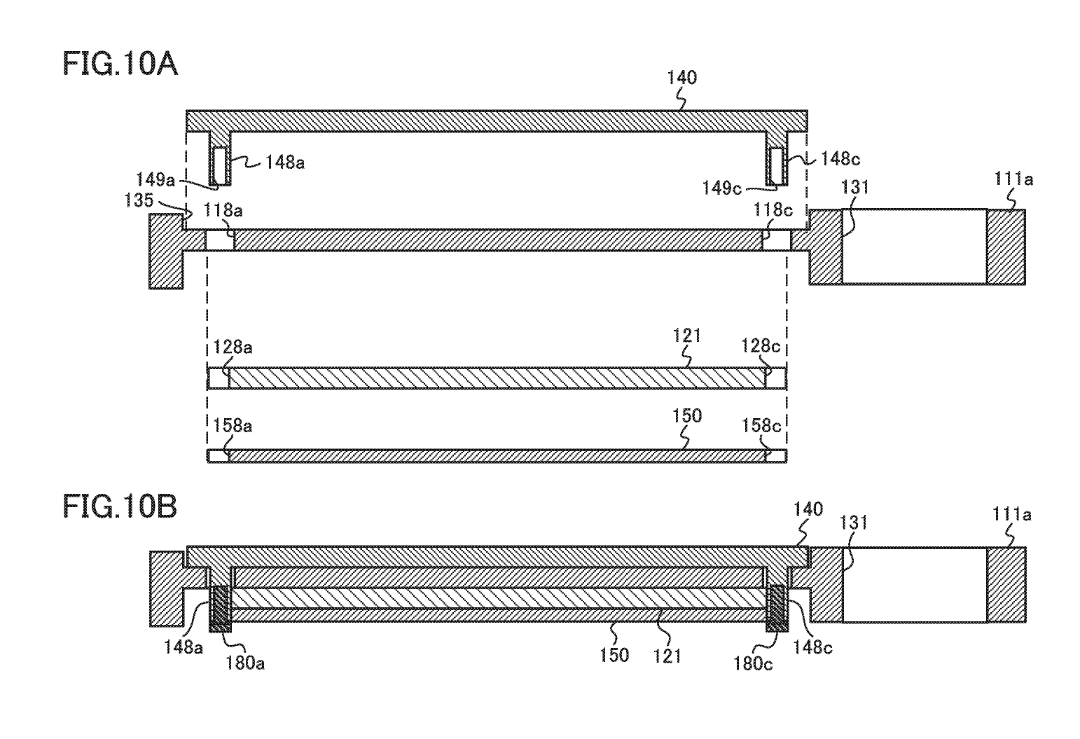

FIG. 8A shows individual cross-sectional views of the key cover 140, upper case 111a, rubber key 121, and printed wiring board 150 at the line A-A situated in the center of each member in the width direction. On the other hand, FIG. 9A shows individual cross-sectional views of these four members at the line B-B passing through the two positioning pins 146a and 146b provided on the key cover 140. Moreover, FIG. 10A shows individual cross-sectional views of these four members at the line C-C passing through the two protrusions 148a and 148c among the four protrusions 148a to 148d provided on the key cover 140. For avoiding intricacy and easier understanding, FIGS. 8A to 10B show only the cross-sectional configurations of the members at the lines (A-A, B-B, and C-C) and the configurations supposed to be seen far off (behind) the cross-section are eliminated. Moreover, FIGS. 8A to 10B show the cross sections with hatching and the openings and notches in contour.

As shown in FIGS. 8A, 9A, and 10A, from the front side (outside) of the enclosure 110, the key cover 140, upper case 111a, rubber key 121, and printed wiring board 150 are superposed in this order and assembled into a single fixed article.

A specific assembling process (production method) will be described in the following (1) to (4).

(1) First, the key cover 140 is fitted in the recess 135 of the upper case 111a. At this point, the positioning pins 146a and 146b provided on the key cover 140 are passed through the third openings 116a and 116b of the upper case 111a, respectively. As a result, the corresponding openings between the first openings 112, 113, and 114 of the upper case 111a and the second openings 142, 143, and 144 of the key cover 140 align with each other with high accuracy. Moreover, at this point, the fixing protrusions 148a to 148d provided on the key cover 140 are inserted into the openings 118a to 118d of the upper case 111a, respectively.

(2) Secondly, the press keys 122, 123, and 124 provided on the rubber key 121 are passed through the first openings 112, 113, and 114 of the upper case 111a and the second openings 142, and 143, and 144 of the key cover 140, which are in the superposed state, whereby the rubber key 121 is attached to the upper case 111a. At this point, the positioning pins 146a and 146b passed through the third openings 116a and 116b are further passed through the fourth openings 126a and 126b of the rubber key 121, respectively. As a result, the press keys 122, 123, and 124, the first openings 112, 113, and 114, and the second openings 142, 143, and 144 are positionally aligned with high accuracy. Moreover, at this point, the fixing protrusions 148a to 148d are inserted into the notches 128a to 128d of the rubber key 121, respectively.

(3) Thirdly, the printed wiring board 150 is attached to the rubber key 121 so that the press keys 122, 123, and 124 are each superposed on the corresponding electrode among the electrodes 152, 153, and 154 provided on the printed wiring board 150. At this point, the positioning pins 146a and 146b passed through the third openings 116a and 116b and fourth openings 126a and 126b are further passed through the fifth openings 156a and 156b formed in the printed wiring board 150, respectively. As a result, the printed wiring board 150 can be precisely positioned with respect to the other members. Moreover, at this point, the fixing protrusions 148a to 148d are inserted into the notches 158a to 158d of the printed wiring board 150, respectively.

(4) Fourthly, in the state of being positioned by the positioning pins 146a and 146b, the screws 180a to 180d are inserted into the screw holes 149a to 149d of the protrusions 148a to 148d, respectively, and fastened. Fastening the screws 180a to 180d results in applying a force fastening the members in the direction perpendicular to their surfaces. Consequently, the key cover 140, upper case 111a, rubber key 121, and printed wiring board 150 are fixed.

As a result of the four members being superposed in sequence as described above, the key cover 140, upper case 111a, rubber key 121, and printed wiring board 150 are assembled as shown in FIGS. 8B, 9B, and 10B.

As shown in FIG. 8B, after assembled, the press keys 122, 123, and 124 provided on the rubber key 121 are inserted in both the first openings 112, 113, and 114 formed in the upper case 111a and the second openings 142, 143, and 144 formed in key cover 140, and protrude from the surface of the key cover 140 to a given height so that the user can easily press the press keys 122, 123, and 124.

Moreover, as shown in FIG. 9B, the positioning pins 146a and 146b provided on the key cover 140 are inserted in the upper case 111a, rubber key 121, and printed wiring board 150 at the same time. Therefore, the four members are positioned with reference to the positioning pins 146a and 146b that are common positioning members. Consequently, the four members can be positioned with high accuracy.

In other words, for example, if a member for positioning the key cover 140 and upper case 111a and a member for positioning the upper case 111a and rubber key 121 are separate members, the key cover 140 and rubber key 121 are positioned only indirectly, whereby a larger positioning error may occur. Moreover, a larger number of fixing members such as screws are required. Therefore, it is difficult in a relatively small device such as the printing device 100 according to this embodiment to smoothly insert each of the press keys 122, 123, and 124 arranged closely in a small region into the two openings formed in the upper case 111a and key cover 140.

In order to prevent the above problem, for example, a large opening into which the press keys 122, 123, and 214 are inserted all together may be formed instead of openings corresponding to the press keys 122, 123, and 144 on a one-to-one basis such as the first openings 112, 113, and 114 of the upper case 111a. As a result, the press keys 122, 123, and 124 are each inserted into only one opening, whereby the accuracy of positioning is not required compared to the case of being inserted into two openings. However, if a large opening is formed in the portion of the upper case 111a where the press keys 122, 123, and 124 are inserted, the strength of the enclosure 110 is lowered.

In the printing device 100 according to this embodiment, the positioning pins 146a and 146b that are common positioning members are used for positioning, whereby the press keys 122, 123, and 124 can each be inserted into both two openings formed in the upper case 111a and key cover 140 with excellent accuracy. Consequently, with the key cover 140 covering the portion of the upper case 111a where the first openings 112, 113, and 114 are formed, which is likely to receive a load due to pressing operations of the user, the strength of the printing device 100 can be improved. Moreover, using the key cover 140 different in color from the upper case 111a, the printing device 100 can be improved in design (industrial design).

Furthermore, in the printing device 100 according to this embodiment, accurate positioning by the common positioning members makes it possible to insert the protrusions 148a to 148d provided on the key cover 140 into the upper case 111a, rubber key 121, and printed wiring board 150 at the same time as shown in FIG. 10B. Therefore, in the printing device 100 according to this embodiment, the four members, the key cover 140, upper case 111a, rubber key 121, and printed wiring board 150, can collectively be fixed with a small number of fixing members, namely four screws 180a to 180d.

### Modified Embodiments

An embodiment of the present disclosure is described above. The above-described embodiment is given by way of example and the scope of application of the present disclosure is not confined to this embodiment. In other words, the embodiment of the present disclosure is applicable in a variety of manners and any mode of implementation is included in the scope of the present disclosure.

For example, in the above-described embodiment, the electronic device according to the present disclosure is the printing device 100 that is a label printer by way of example.

However, the electronic device according to the present disclosure is not confined to printing devices such as label printers. The electronic device according to the present disclosure may be, for example, an electronic dictionary, desk calculator, cell-phone, some other computer, or the like as long as the device has protruding pressing parts such as keys, buttons, or the like.

Moreover, in the above-described embodiment, the pressing member is the rubber key 121 by way of example. However, the pressing member in the present disclosure may be made of some materials other than rubber such as synthetic resin as long as the pressing member has protruding pressing parts.

Moreover, in the above-described embodiment, the rubber key 121 that is the pressing member has plural press keys 122, 123, and 124 arranged in a plane as the pressing parts. However, as long as arranged in a surface, the plural pressing parts in the present disclosure may be arranged in a curved surface, not in a completely two-dimensional plane. For example, where an electronic device includes an enclosure having a curved surface and the pressing member is accordingly curved, the plural pressing parts are arranged in a curved surface.

Moreover, the pressing member in the present disclosure may have only one pressing part, not plural pressing parts. Even where the pressing member has only one pressing part, with the pressing member and plural opening-formed members being positioned by the common positioning members as in the above-described embodiment, the pressing part can be inserted into plural openings with excellent accuracy. In this regard, where plural pressing parts are arranged closely in a small region as in the case of plural pressing parts being arranged in a grid in a small device, there is no dimensional allowance (margin) for plural openings into which the plural pressing parts are inserted; therefore, the pressing parts and openings have to be positioned with higher accuracy. Thus, the efficacy of the present disclosure is enhanced where the pressing member has plural pressing parts arranged closely.

Moreover, in the above-described embodiment, the positioning pins 146a and 146b are provided to the key cover 140 that is the outermost member of the printing device 100.

However, in the present disclosure, it may be possible to provide on the printed wiring board 150 or rubber key 121, which are inner members of the printing device 100, positioning pins protruding outward and form in the key cover 140 openings into which the positioning pins are inserted. In such a case, with the positioning pins provided on the printed wiring board 150 or rubber key 121 being inserted into the openings formed in the upper case 111a and key cover 140, the four members are mutually positioned. Similarly, it may be possible to provide the fixing protrusions 148a to 148d provided on the key cover 140 in the above-described embodiment on the printed wiring board 150 or rubber key 121, which are inner members of the printing device 100. In this regard, providing openings in the outermost member of the printing device 100 leads to impairing the appearance of the printing device 100 in design. Therefore, it is preferable in consideration of design to provide on the key cover 140 the positioning pins 146a and 146b and protrusions 148a to 148b oriented inside of the printing device 100 as in the above-described embodiment.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. An electronic device comprising:
a pressing member including plural pressing parts;
a first opening-formed member including plural first openings in which the plural pressing parts are inserted so as to individually protrude out of the first openings;
a second opening-formed member including plural second openings in which the plural pressing parts inserted in the plural first openings are inserted so as to individually protrude out of the first openings and the second openings; and
at least one positioning member positioning the pressing member, the first opening-formed member, and the second opening-formed member so that the plural pressing parts are disposed at positions where the plural pressing parts are inserted in the plural first openings and the plural second openings.

2. The electronic device according to claim 1, wherein the second opening-formed member includes at least one positioning protrusion as the at least one positioning member,
the first opening-formed member includes at least one third opening,
the pressing member includes at least one fourth opening, and
the pressing member, the first opening-formed member, and the second opening-formed member are positioned by the at least one positioning protrusion being inserted into the at least one third opening and the at least one fourth opening.

3. The electronic device according to claim 2, further comprising:
a signal processing member including circuits processing signals generated when at least one of the plural pressing parts is pressed and including at least one fifth opening,
wherein the pressing member, the first opening-formed member, the second opening-formed member, and the signal processing member are positioned by the at least one positioning protrusion being inserted into the at least one third opening, the at least one fourth opening, and the at least one fifth opening.

4. The electronic device according to claim 1, wherein
the plural pressing parts are arranged in a plane.

5. The electronic device according to claim 1, wherein
the pressing member, the first opening-formed member, and the second opening-formed member are fixed by plural fixing members.

6. The electronic device according to claim 3, wherein
the pressing member, the first opening-formed member, the second opening-formed member, and the signal processing member are fixed by plural fixing members.

7. The electronic device according to claim 1, wherein
the first opening-formed member constitutes a body of the electronic device at least in part, and
the second opening-formed member covers a surface of the first opening-formed member in part.

8. The electronic device according to claim 1, wherein
the second opening-formed member is placed in a recess formed in a surface of the first opening-formed member.

9. The electronic device according to claim 1, wherein
the second opening-formed member is different in color from the first opening-formed member.

10. The electronic device according to claim 3, wherein
the signal processing member includes an electrode,
the circuits of the signal processing member process signals generated when at least one of the plural pressing parts is pressed and a topper of the at least one pressed pressing part is pressed down under a load by the pressing and makes contact with the electrode of the signal processing member.

11. A printing device comprising:
the electronic device according to claim 1; and
a printing mechanism for printing a print pattern regarding data entered by an input part on a printing medium.

12. The printing device according to claim 11, further comprising:
a display displaying information regarding data entered by the input part.

13. An electronic device production method comprising:
preparing a pressing member including plural pressing parts, a first opening-formed member including plural first openings in which the plural pressing parts are inserted so as to individually protrude out of the first openings, a second opening-formed member including plural second openings in which the plural pressing parts inserted in the plural first openings are inserted so as to individually protrude out of the first openings and the second openings, and at least one positioning member positioning the pressing member, the first opening-formed member, and the second opening-formed member so that the plural pressing parts are disposed at positions where the plural pressing parts are inserted in the plural first openings and the plural second openings;
assembling the first opening-formed member and second opening-formed member so that the positioning member positions the second opening-formed member on one surface of the first opening-formed member in the manner that the plural first openings align with the plural second openings; and
assembling the first opening-formed member and the pressing member so that the positioning member positions the pressing member on the other surface of the first opening-formed member in the manner that the plural pressing parts are inserted into the plural first openings and the plural second openings corresponding to the plural pressing parts after assembled.

14. The electronic device production method according to claim 13, wherein
the second opening-formed member includes at least one positioning protrusion as the at least one positioning member,
the first opening-formed member includes at least one third opening,
the pressing member includes at least one fourth opening, and
the pressing member, the first opening-formed member, and the second opening-formed member are positioned by inserting the at least one positioning protrusion into the at least one third opening and the at least one fourth opening.

15. The electronic device production method according to claim 14, further comprising:
further preparing a signal processing member including circuits processing signals generated when at least one of the plural pressing parts is pressed and including at least one fifth opening; and
positioning the pressing member, the first opening-formed member, the second opening-formed member, and the signal processing member by inserting the at least one positioning protrusion into the at least one third opening, the at least one fourth opening, and the at least one fifth opening.

16. The electronic device production method according to claim 13, further comprising:
fixing the pressing member, the first opening-formed member, and the second opening-formed member by plural fixing members.

17. The electronic device production method according to claim 15, further comprising:
fixing the pressing member, the first opening-formed member, the second opening-formed member, and the signal processing member by plural fixing members.
